(19) United States
(12) Patent Application Publication
(10) Pub. No.: US 2018/0334367 A1
(43) Pub. Date: Nov. 22, 2018

(54) WHEEL MOUNTING DEVICE

(71) Applicant: CITIC Dicastal CO.,LTD, Qinhuangdao (CN)

(72) Inventors: Yao ZHENG, Qinhuangdao (CN); Jiandong GUO, Qinhuangdao (CN); Bowen XUE, Qinhuangdao (CN); Donghui ZHANG, Qinhuangdao (CN); Xiaoguang HUANG, Qinhuangdao (CN); Huiying LIU, Qinhuangdao (CN)

(73) Assignee: CITIC Dicastal CO.,LTD, Qinhuangdao (CN)

(21) Appl. No.: 15/692,597

(22) Filed: Aug. 31, 2017

(30) Foreign Application Priority Data
May 19, 2017 (CN) 2017103587266

(51) Int. Cl. B66F 9/04; B66F 7/06; B66F 7/26; B66F 9/06

(52) U.S. Cl. CPC B66F 9/04; B66F 7/0616; B62D 21/03; B66F 9/063; B66F 7/26

(57) ABSTRACT

The present application discloses an improved wheel mounting device. A support is fixed on a base, a flange positioning plate is fixed on the support, a sliding sleeve is fixed on the flange positioning plate, a sleeve is fixed with the sliding sleeve, a strut slides in the sleeve and a movable pin, the strut passes through the sleeve via a screw, the sleeve is tightened together with the strut, a spring I is put in the sleeve and the strut to adjust the vertical position of the strut, the movable pin moves up and down in the sliding sleeve, a spring II is put in the movable pin and the sleeve to adjust the vertical position of the movable pin.

### CROSS-REFERENCE TO RELATED APPLICATIONS

This application claims priority to Chinese Patent Application No. 201710358726.6, filed on May 19, 2017, which is hereby incorporated by reference in its entirety.

### TECHNICAL FIELD

The present application relates to a fixture for a wheel manufacturing procedure, and specifically, to a device for bonding and fit between a composite wheel base body and upper and lower flange plates.

### BACKGROUND ART

As national energy-saving and environment-friendly requirements are put forward, energy conservation and emission reduction in the automobile industry cannot be delayed even a moment. Lightweight of automobiles is one of the most effective means for energy conservation and emission reduction of the automobiles. The lightweight energy-saving effect of the wheel serving as a high-speed rotating unsprung mass is more remarkable than that of other parts, so the lightweight development of wheels has been an irresistible trend, wherein the wheels made of carbon fibers have been developed in the industry, and are different from conventional wheels in structure and machining mode.

The carbon fiber wheel is different from a conventional aluminum alloy wheel and a conventional steel wheel in structure, the wheel base body is made of carbon fibers, two high-performance aluminum alloy plates are arranged on the front side of the wheel and a flange, and the two aluminum alloy plates need to be bonded and pressed into the carbon fiber wheel body in interference fit during machining.

### SUMMARY OF THE INVENTION

The present application is aimed at providing a composite wheel mounting device.

The present application adopts the following technical solution: an improved wheel mounting device comprises a base, a support, screws, springs I, sleeves, a flange positioning plate, sliding sleeves, springs II, movable pins, struts, a pressure cylinder, a connecting plate, guide posts, upper guide post flanges, a connector, lower guide post flanges and a pressure plate. The support is fixed on the base, the flange positioning plate is fixed on the support, the sliding sleeve is fixed on the flange positioning plate, the sleeve is fixed with the sliding sleeve, the strut slides in the sleeve and the movable pin, the strut passes through the sleeve and the sleeve is tightened together with the strut, and the spring I is put in the sleeve and the strut to adjust the vertical position of the strut. The movable pin moves up and down in the sliding sleeve, and the spring II is put in the movable pin and the sliding sleeve to adjust the vertical position of the movable pin. The upper guide post flanges are fixed on the base, and the guide posts pass through the upper guide post flanges and are fixed on the pressure plate together with the lower guide post flanges. The pressure cylinder and the connecting plate are fixed on the base, a pressure cylinder rod is connected with the connector, and the connector is fixed on the pressure plate.

In practical use, a lower flange plate is put on the upper surface of the movable pin, the upper surface of the lower flange plate is coated with a special bonding compound, then bolt holes of a carbon fiber wheel base body are aligned with the guide posts and the movable pin, the carbon fiber wheel base body is put on the lower flange plate, and the lower surface of an upper flange plate is coated with the special bonding compound and aligned with the bolt holes of the carbon fiber wheel base body.

When the upper flange plate is aligned with the bolt holes of the base body, the cylinder rod of the pressure cylinder moves down and drives the connector and the pressure plate to move, the guide posts move up and down in the upper guide post flanges and the lower guide post flanges to achieve a guiding effect, and the pressure plate moving down presses the upper flange plate to gradually press bosses at the bolt holes of the upper flange plate into the carbon fiber wheel base body; the strut begins moving down under pressure, then when the spring I is in a maximum pressed state, the head of the strut presses the movable pin and pushes the movable pin to move down, till the movable pin is separated from the lower flange plate, the lower flange plate contacts the flange positioning plate, and the lower flange plate at the moment has arrived at the limit position; the pressure plate continuously presses down, the bosses of the upper flange plate have been pressed into the carbon fiber wheel base body at the moment, then when the pressure reaches a certain value, the pressure value is kept for certain time, and bonding and interference fit between the carbon fiber wheel and the upper and lower flange plates are thus completed. Then, the pressure cylinder is depressurized, the pressure plate moves up to the original position, and the mounting procedure of the carbon fiber wheel is finally realized.

The improved wheel mounting device of the present application in use may meet the requirement for clamping when the carbon fiber wheel is machined, replaces artificial processing, and is ideal in effect, high in efficiency and safe and reliable in operation.

### BRIEF DESCRIPTION OF DRAWINGS

FIG. 1 is a structural schematic diagram of an improved wheel mounting device of the present application.

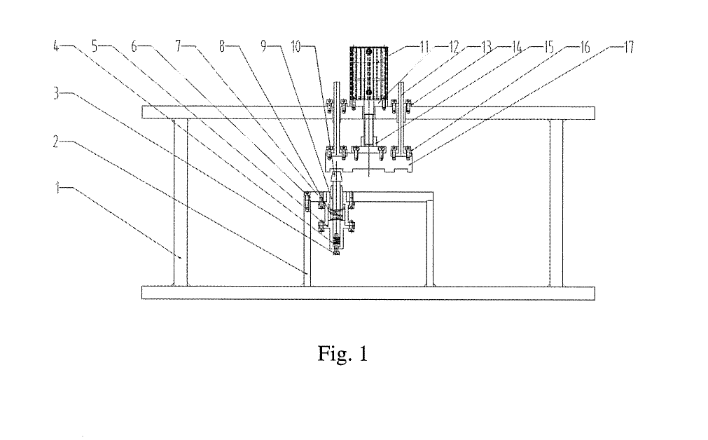

FIG. 2 is a top view of the improved wheel mounting device of the present application.

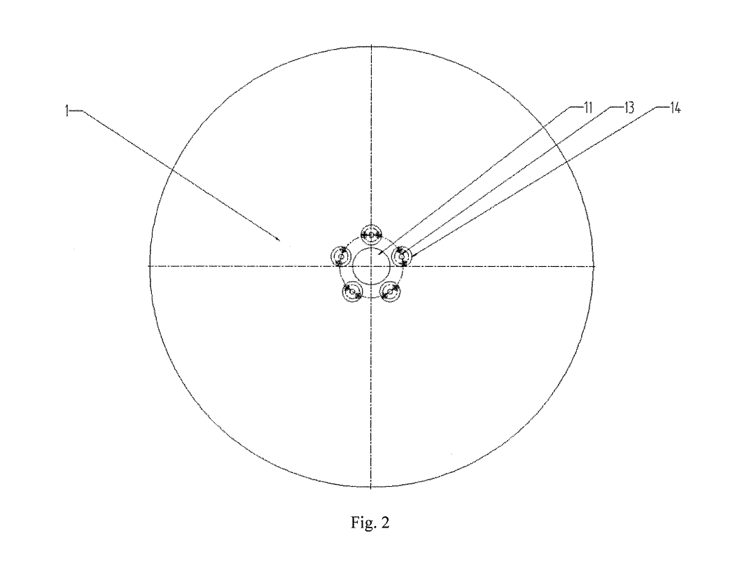

FIG. 3 is a structural schematic diagram when the improved wheel mounting device of the present application works.

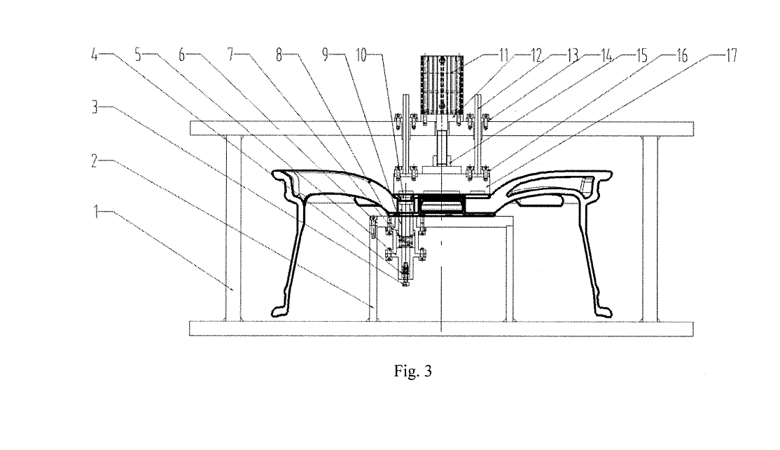

In figures: 1—base, 2—support, 3—screw, 4—spring I, 5—sleeve, 6—flange positioning plate, 7—sliding sleeve, 8—spring II, 9—movable pin, 10—strut, 11—pressure cylinder, 12—connecting plate, 13—guide post, 14—upper guide post flange, 15—connector, 16—lower guide post flange, 17—pressure plate.

### DETAILED DESCRIPTION OF THE INVENTION

The details and working conditions of the specific device provided by the present application will be described below in combination with the accompanying drawings.

An improved wheel mounting device is composed of a base 1, a support 2, screws 3, springs I 4, sleeves 5, a flange positioning plate 6, sliding sleeves 7, springs II 8, movable pins 9, struts 10, a pressure cylinder 11, a connecting plate 12, guide posts 13, upper guide post flanges 14, a connector 15, lower guide post flanges 16 and a pressure plate 17. The support 2 is fixed on the base 1 by welding, the flange positioning plate 6 is fixed on the support 2 via six bolts, the sliding sleeve 7 is fixed on the flange positioning plate 6 via bolts, the sleeve 5 is fixed with the sliding sleeve 7 via bolts, the strut 10 slides in the sleeve 5 and the movable pin 9, the strut 10 passes through the sleeve 5 via the screw 3 and the sleeve 5 is tightened together with the strut 10, the spring I 4 is put in the sleeve 5 and the strut 10 to adjust the vertical position of the strut 10, the movable pin 9 slides up and down in the sliding sleeve 7, the spring II 8 is put in the movable pin 9 and the sliding sleeve 7 to adjust the vertical position of the movable pin 9, the upper guide post flanges 14 are fixed on the base 1 via bolts, the guide posts 13 pass through the upper guide post flanges 14 and are fixed on the pressure plate 17 together with the lower guide post flanges 16 via bolts, the pressure cylinder 11 and the connecting plate 12 are fixed on the base 1 by using bolts, a pressure cylinder rod is in threaded connection with the connector 15, and the connector 15 is fixed on the pressure plate 17 via a bolt.

In the working process, a lower flange plate is put on the upper surface of the movable pin 9, the upper surface of the lower flange plate is coated with a special bonding compound, then bolt holes of a carbon fiber wheel base body are aligned with the guide posts 13 and the movable pin 9, the carbon fiber wheel base body is put on the lower flange plate, and the lower surface of an upper flange plate is coated with the special bonding compound and aligned with the bolt holes of the carbon fiber wheel base body.

When the upper flange plate is aligned with the bolt holes of the carbon fiber wheel base body, the cylinder rod of the pressure cylinder 11 moves down and drives the connector 15 and the pressure plate 17 to move, the guide posts 13 move up and down in the upper guide post flanges 14 and the lower guide post flanges 16 to achieve a guiding effect, and the pressure plate 17 moving down presses the upper flange plate to gradually press bosses at the bolt holes of the upper flange plate into the carbon fiber wheel base body; the strut 10 begins moving down under pressure, then when the spring I 4 is in a maximum pressed state, the head of the strut 10 presses the movable pin 9 and pushes the movable pin 9 to move down, till the movable pin 9 is separated from the lower flange plate, the lower flange plate contacts the flange positioning plate 6, and the lower flange plate at the moment has arrived at the limit position; the pressure plate 17 continuously presses down, the bosses of the upper flange plate have been pressed into the carbon fiber wheel base body at the moment, then when the pressure reaches a certain value, the pressure value is kept for certain time, and bonding and interference fit between the carbon fiber wheel and the upper and lower flange plates are thus completed. Then, the pressure cylinder 11 is depressurized, the pressure plate moves up to the original position, and the mounting procedure of the carbon fiber wheel is finally realized.

The foregoing descriptions of specific exemplary embodiments of the present application have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present application, as well as various alternatives and modifications thereof. It is intended that the scope of the invention be defined by the Claims appended hereto and their equivalents.

1. An improved wheel mounting device comprising a base, a support, screws, first springs, sleeves, a flange positioning plate, sliding sleeves, second springs, movable pins, struts, a pressure cylinder, a connecting plate, guide posts, upper guide post flanges, a connector, lower guide post flanges and a pressure plate, wherein the support is fixed on the base, the flange positioning plate is fixed on the support, the sliding sleeve is fixed on the flange positioning plate, the sleeve is fixed with the sliding sleeve, the strut slides in the sleeve and the movable pin, the strut passes through the sleeve via the screw, the sleeve is tightened together with the strut, each of the first springs is put in the sleeve and the strut to adjust the vertical position of the strut, the movable pin moves up and down in the sliding sleeve, each of the second springs is put in the movable pin and the sliding sleeve to adjust the vertical position of the movable pin, the upper guide post flanges are fixed on the base, the guide posts pass through the upper guide post flanges and are fixed on the pressure plate together with the lower guide post flanges, the pressure cylinder and the connecting plate are fixed on the base, a pressure cylinder rod is in threaded connection with the connector, and the connector is fixed on the pressure plate.
